(19) United States
(12) Patent Application Publication
(10) Pub. No.: US 2019/0379618 A1
(43) Pub. Date: Dec. 12, 2019

(54) PRESENTING VISUAL MEDIA

(71) Applicant: Gfycat, Inc., Palo Alto, CA (US)

(72) Inventors: Richard RABBAT, Palo Alto, CA (US); Ernestine FU, Northridge, CA (US); Hanna XU, Sunnyvale, CA (US)

(73) Assignee: Gfycat, Inc., Palo Alto, CA (US)

(21) Appl. No.: 16/438,274

(22) Filed: Jun. 11, 2019

Related U.S. Application Data
(60) Provisional application No. 62/683,565, filed on Jun. 11, 2018.

(51) Int. Cl. H04L 12/58; G06F 3/0482; G06F 17/27

(52) U.S. Cl. CPC H04L 51/10; G06F 17/27; G06F 3/0482

(57) ABSTRACT

In a computer-implemented method for presenting visual media, a text string including communication between a first user using a messaging application at a first electronic device and a second user using the messaging application at a second electronic device is received. The text string is analyzed to identify a sentiment of the communication. Visual media representative of the sentiment is displayed within the messaging application and proximate the communication.

### RELATED APPLICATIONS

This application claims priority to and the benefit of co-pending U.S. Patent Provisional Patent Application 62/683,565, filed on Jun. 11, 2018, entitled “LIVING CANVAS,” by Rabbat et al., having Attorney Docket No. GFYCAT-011.PRO, and assigned to the assignee of the present application, which is incorporated herein by reference in its entirety.

### BACKGROUND

In recent years, mobile electronic devices, such as cell phones and smart phones, have become ubiquitous sources of communication. For instance, mobile electronic devices used for voice communication, text messaging, electronic mail (email), file sharing, etc. Moreover, messaging applications are increasingly being used to communicate media files, such as Graphics Interchange Format (GIF) files.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 illustrates an example computer system upon which embodiments described herein may be implemented.

FIG. 2 illustrates an example network upon which embodiments described herein may be implemented.

FIG. 3 illustrates a system for selecting and presenting visual media for display within a conversation, in accordance with various embodiments.

FIGS. 4-6 illustrate screenshots of examples of automatic sending of a media file, according to various embodiments.

FIG. 7 illustrates screenshots of an example of a media file as mood lighting, according to embodiments.

FIGS. 8, 9A and 9B illustrate flow diagrams of an example method for presenting visual media, according to various embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following

### DETAILED DESCRIPTION

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical circuit. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “analyzing,” “displaying,” “selecting,” “providing,” “extracting,” “identifying,” or the like, refer to the actions and processes of an electronic device such as: a processor, a memory, a computing system, a mobile electronic device, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example computer system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example computer system upon which embodiments of the present invention may be implemented. A description of embodiments of a system for selection and presentation of media files are then described. Example operations of automatic sending or presentation of media files are then described.

In accordance with various embodiments, methods for selecting presenting visual media, are described. A text string including communication between a first user using a messaging application at a first electronic device and a second user using the messaging application at a second electronic device is received. The text string is analyzed to identify a sentiment of the communication. Visual media representative of the sentiment is displayed within the messaging application and proximate the communication.

With the proliferation of digital communication as a frequent replacement for in-person or voice communications, tone or sentiment of a conversation may be muted by the digital communication. For instance, some phrases (e.g., “I love you” or “congratulations!”) may lose their meaning or intention when presented in a digital format. As a result, the conversation may not be a complete representation of the tone to the participants.

Embodiments described herein pertain to the selection and presentation of visual media to enhance communication between at least two users of a messaging application. Messaging applications are available for communication between users on many computer systems, such as mobile electronic devices. For example, Apple's iOS Messages, also known as iMessage, is the native messaging application available in Apple's iPhone and iPad product line. Many different messaging applications exist, and can be native to a device, native to an operating system, or third-party applications. Examples of other messaging applications include, but are not limited to: Android Messages, Facebook Messenger, etc. It should be appreciated that embodiments described herein may be implemented within any messaging application that allows for the transmission of electronic messages and media files, and is not intended to be limited to any particular messaging application.

Embodiments described herein pertain to selecting and presenting visual media within a messaging application. It should be appreciated that the visual media may include, without limitation, images, animations, videos, emojis, or any other type of visual media that can be displayed electronically. In one embodiment, the media files are Graphics Interchange Format (GIF) files. While embodiments described herein pertain to GIF files, it should be appreciated that other types of media files, such as other types of video files and audio files, can be used herein. Moreover, it should be appreciated that any type of media file format can be used in accordance with the described embodiments, including but not limited to GIF, WebM, WebP, MPEG-4 (MP4), Animated Portable Network Graphics (APNG), Motion JPEG, Flash video (FLV), Windows Media video, M4V, MPEG-1 or MPEG-2 Audio Layer III (MP3), etc.

In accordance with some embodiments, a conversation is analyzed to determine the sentiment of the conversation. The sentiment can refer to the mood or tenor of the conversation (e.g., happy, sad, angry) or can refer to a subject or import of the conversation (e.g., celebrating an anniversary or graduation) and can be identified by analyzing the words and phrases of the conversation.

An item of visual media is selected based on the sentiment of the conversation. In one embodiment, the visual media item is automatically selected based on the sentiment. In another embodiment, a plurality of visual media items corresponding to the sentiment are displayed for selection by one participant in the conversation. The visual media item is displayed within the messaging application proximate the communication to visually enhance the conversation.

In accordance with some embodiments, a text string is analyzed to understand the sentiment of a communication. One or more sentiments are identified, each sentiment having an associated confidence level. The confidence level is used for relative ranking of the likelihood of a particular sentiment. In some embodiments, the confidence level is compared to a confidence threshold. For example, the top sentiment of a ranking of possible sentiments may only be identified if the confidence level satisfies the confidence threshold. The identified sentiment is used to identify at least one item of visual media that corresponds to that sentiment. A selected visual media item is displayed proximate the communication (e.g., below, above, under, over, or next to).

As presented above, providing enhancements to digital means of communication is important for facilitating the use of digital content. Providing automatic visual enhancements to a conversation to capture a sentiment of the conversation improves the user experience for the participants without requiring users to search for particular visual media. Hence, the embodiments described herein greatly extend beyond conventional methods of selecting and presenting for visual media. Moreover, embodiments of the present invention amount to significantly more than merely using a computer to select and present visual media. Instead, embodiments of the present invention specifically recite a novel process, rooted in computer technology, utilizing an automated analysis of a conversation to identify a sentiment of the conversation, and to present visual media to enhance the conversation, thereby improving the user experience.

### Example Computer System

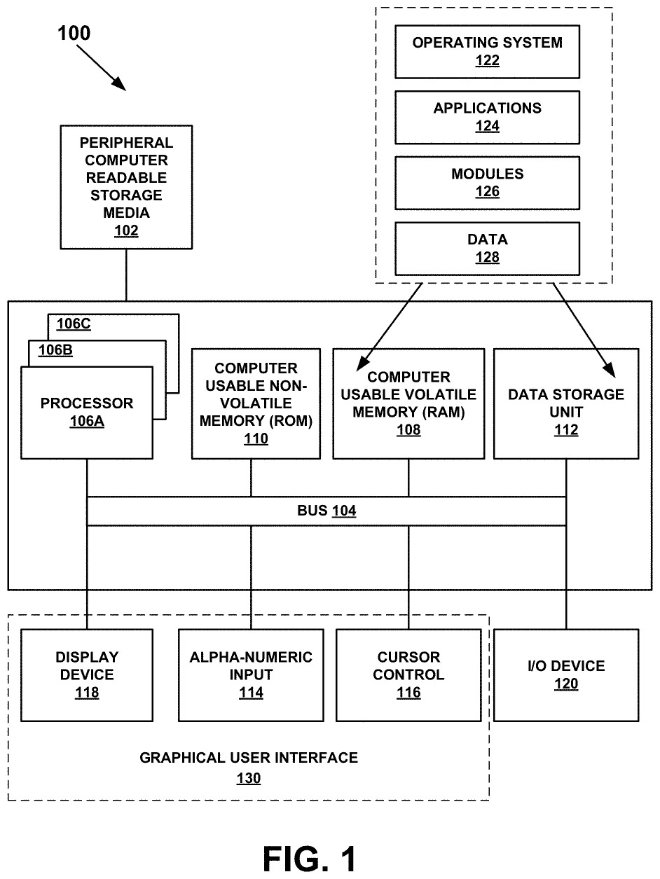

Turning now to the figures, FIG. 1 is a block diagram of an example computer system 100 upon which embodiments of the present invention can be implemented. FIG. 1 illustrates one example of a type of computer system 100 (e.g., a computer system) that can be used in accordance with or to implement various embodiments which are discussed herein.

It is appreciated that computer system 100 of FIG. 1 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, stand alone computer systems, media centers, handheld computer systems, multi-media devices, and the like. In some embodiments, computer system 100 of FIG. 1 is well adapted to having peripheral tangible computer-readable storage media 102 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 100 of FIG. 1 includes an address/data bus 104 for communicating information, and a processor 106A coupled with bus 104 for processing information and instructions. As depicted in FIG. 1, computer system 100 is also well suited to a multi-processor environment in which a plurality of processors 106A, 106B, and 106C are present. Conversely, computer system 100 is also well suited to having a single processor such as, for example, processor 106A. Processors 106A, 106B, and 106C may be any of various types of microprocessors. Computer system 100 also includes data storage features such as a computer usable volatile memory 108, e.g., random access memory (RAM), coupled with bus 104 for storing information and instructions for processors 106A, 106B, and 106C. Computer system 100 also includes computer usable non-volatile memory 110, e.g., read only memory (ROM), coupled with bus 104 for storing static information and instructions for processors 106A, 106B, and 106C. Also present in computer system 100 is a data storage unit 112 (e.g., a magnetic or optical disc and disc drive) coupled with bus 104 for storing information and instructions. Computer system 100 also includes an alphanumeric input device 114 including alphanumeric and function keys coupled with bus 104 for communicating information and command selections to processor 106A or processors 106A, 106B, and 106C. Computer system 100 also includes a cursor control device 116 coupled with bus 104 for communicating user input information and command selections to processor 106A or processors 106A, 106B, and 106C. In one embodiment, computer system 100 also includes a display device 118 coupled with bus 104 for displaying information.

Referring still to FIG. 1, display device 118 of FIG. 1 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 116 allows the computer user to dynamically signal the movement of a visible symbol (cursor) on a display screen of display device 118 and indicate user selections of selectable items displayed on display device 118. Many implementations of cursor control device 116 are known in the art including a trackball, mouse, touch pad, touch screen, joystick or special keys on alphanumeric input device 114 capable of signaling movement of a given direction or manner of displacement. Alternatively, it will be appreciated that a cursor can be directed and/or activated via input from alphanumeric input device 114 using special keys and key sequence commands. Computer system 100 is also well suited to having a cursor directed by other means such as, for example, voice commands. In various embodiments, alphanumeric input device 114, cursor control device 116, and display device 118, or any combination thereof (e.g., user interface selection devices), may collectively operate to provide a graphical user interface (GUI) 130 under the direction of a processor (e.g., processor 106A or processors 106A, 106B, and 106C). GUI 130 allows user to interact with computer system 100 through graphical representations presented on display device 118 by interacting with alphanumeric input device 114 and/or cursor control device 116.

Computer system 100 also includes an I/O device 120 for coupling computer system 100 with external entities. For example, in one embodiment, I/O device 120 is a modem for enabling wired or wireless communications between computer system 100 and an external network such as, but not limited to, the Internet. In one embodiment, I/O device 120 includes a transmitter. Computer system 100 may communicate with a network by transmitting data via I/O device 120.

Referring still to FIG. 1, various other components are depicted for computer system 100. Specifically, when present, an operating system 122, applications 124, modules 126, and data 128 are shown as typically residing in one or some combination of computer usable volatile memory 108 (e.g., RAM), computer usable non-volatile memory 110 (e.g., ROM), and data storage unit 112. In some embodiments, all or portions of various embodiments described herein are stored, for example, as an application 124 and/or module 126 in memory locations within RAM 108, computer-readable storage media within data storage unit 112, peripheral computer-readable storage media 102, and/or other tangible computer-readable storage media.

### Example Network and System for Presentation of Visual Media

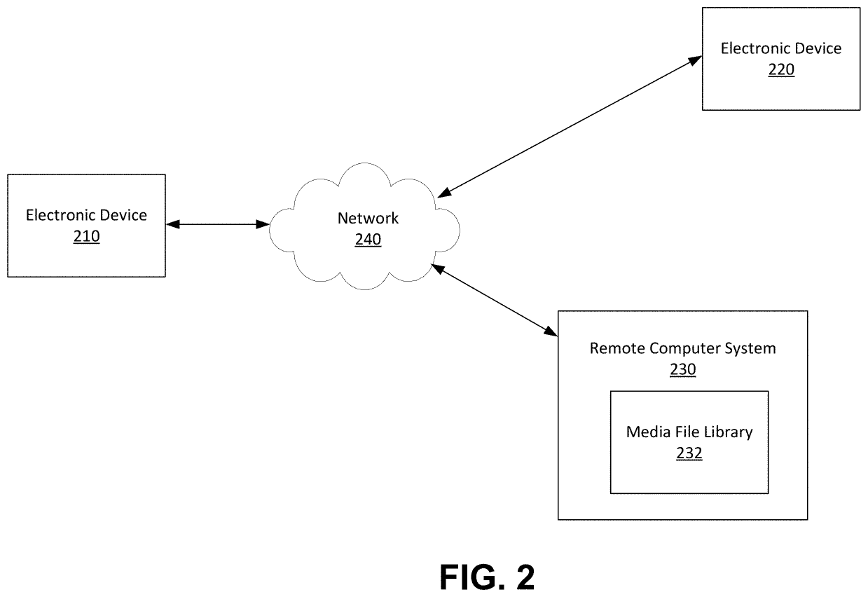

FIG. 2 illustrates an example communication network 240 upon which embodiments described herein may be implemented. FIG. 2 illustrates electronic device 210, electronic device 220, and remote computer system 230, all of which are communicatively coupled via network 240. It should be appreciated that electronic device 210, electronic device 220, and remote computer system 230, may be implemented as a computer system 100, and/or include any combination of the components of computer system 100 in which electronic device 210 and electronic device 220 are able to communicate with each other. In some embodiments, electronic device 210 and electronic device 220 are mobile electronic devices (e.g., smart phones) including messaging applications for communicating electronic messages via a graphical user interface.

In accordance with various embodiments, electronic devices 210 and 220 are capable of transmitting and receiving electronic messages including media files. The media files are capable of being rendered on electronic devices 210 and 220. In some embodiments, electronic devices 210 and 220 are capable of executing a messaging application for communicating messages. The messaging application allows for the attachment of media files within an electronic message for communicating from a sending electronic device to a receiving electronic device. For example, Apple's iOS Messenger is the native messaging application available in Apple's iPhone and iPad product line. Many different messaging applications exist, and can be native to electronic device 210 and/or 220, native to an operating system, or third-party applications. Examples of other messaging applications include, but are not limited to: Android Messages, Facebook Messenger, etc. It should be appreciated that embodiments described herein may be implemented within any messaging application that allows for the transmission of electronic messages and media files, and is not intended to be limited to any particular messaging application.

Electronic devices 210 and 220 may be associated with a particular user. For example, a first user, may be associated with electronic device 210 and a second user, may be associated with electronic device 220. It should be appreciated that a user may be associated with multiple electronic devices, such that a message sent to a particular user may be delivered to more than one electronic device 210 or 220.

In one embodiment, remote computer system 230 is a server including a library of media files 232. A media file can be any type of file that can be rendered on an electronic device 210 or 220 (e.g., an audio file or a video file). It should be appreciated that any type of media file format can be used in accordance with the described embodiments, including but not limited to GIF, WebM, WebP, MPEG-4 (MP4), Animated Portable Network Graphics (APNG), Motion JPEG, Flash video (FLV), Windows Media video, M4V, MPEG-1 or MPEG-2 Audio Layer III (MP3), etc. It should be appreciated that the prerecorded media file can be looped (e.g., via a HTML 5 video element or Flash video element) to automatically repeat.

In some embodiments, electronic devices 210 and 220 are capable of accessing media file library 232 (e.g., via a graphical user interface). A user may navigate through media file library 232 to search and select a media file, e.g., for transmission to a recipient. In some embodiments, access to the library of media files is accessible via an application of an electronic device (e.g., a computer system or a smart phone). It should be appreciated that an electronic device may include media file library 232, or that media file library 232 may be distributed across both an electronic device and remote computer system 230. For example, a subset of media files of media file library 232 may be maintained within memory of electronic device 210 (e.g., frequently used media files) for access that does not require communication over network 240.

In various embodiments, media files are associated with at least one category (e.g., a word, sentence, or phrase) that identifies the subject matter of the media files. Categories are used for sorting media files within the media file library 232, allowing a user to locate or select a particular media file according to their desired message. Media files can be associated with other identifiers, e.g., tags or metadata, that can be searched. For example, the media files can be identified by a sentiment conveyed by the subject matter of the media file, such as a video file of fireworks or popping a cork of a champagne bottles may be associated with the sentiment “celebration.” It should be appreciated that a category associated with a media file can be assigned manually or automatically, and are generally indicative of the depiction presented in the media file (e.g., are searchable). In some embodiments, a category (or categories) associated with a media file may be saved as metadata of the media file. In some embodiments, a category (or categories) associated with a media file may be saved within media file library 232.

For example, a video media file depicting a person blowing out candles on a birthday cake might be associated with the sentiment “Happy Birthday.” Other media files depicting birthday messages (e.g., a video of a movie scene with an actor making a toast accompanied with the caption “Happy Birthday!,” or an audio clip of Marilyn Monroe's famous singing of the Happy Birthday Song to President John F. Kennedy) may also be associated with the sentiment “Happy Birthday.” It should be appreciated that a media file may be associated with multiple categories. For example, a media file of a hamster wearing a birthday hat may be associated with the “Happy Birthday” sentiment, as well other categories such as “Animals,” “Hamsters,” or others.

In accordance with various embodiments, new models of showing relevant content based on what people type are presented. These embodiments can be collectively referred to as a “living canvas” as they operate to modify the display of communications between at least two users. In one embodiment, an application or a website is provided to visually enhance to the typed text being input to the application. For example, in messages shared in a messaging application or as comments typed in a social media application. In another embodiment, an application or a website is provided to present a mood (e.g., mimic the mood lighting that some physical rooms have).

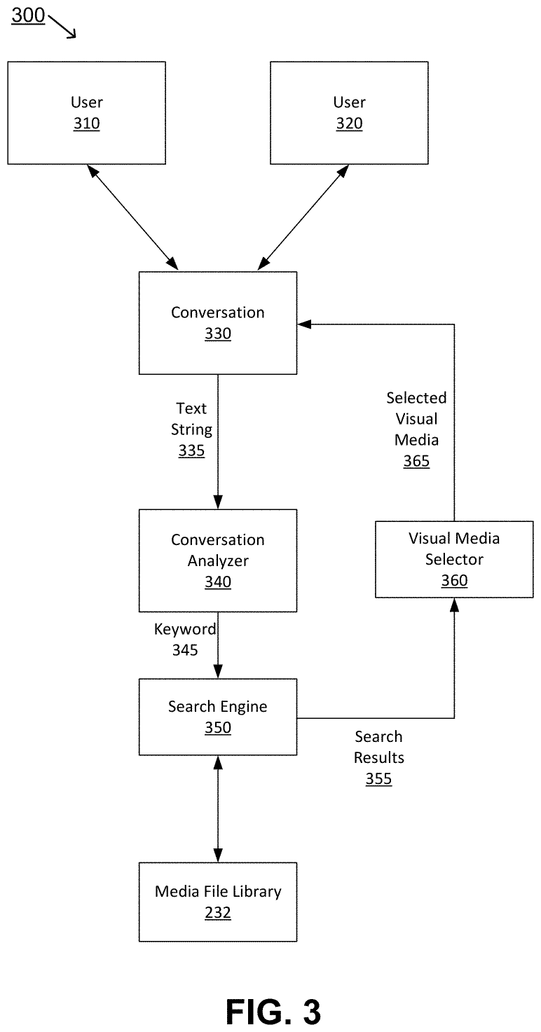

FIG. 3 illustrates an example system 300 for selecting and presenting visual media within a messaging application, in accordance with various embodiments. It should be appreciated that the components of system 300 may be included within any combination of electronic devices, e.g., electronic device 210, electronic device 220, and/or remote computer system 230. In one embodiment, conversation analyzer 340, search engine 350, and visual media selector 360 are located within a remote computer system or distributed computer system.

User 310 and user 320 are participants in conversation 330, each contributing text to conversation 330, the entirety of which is generally available to users 310 and 320. It should be appreciated that there may be more than two user participants in conversation 330, of which the illustrated embodiment is an example. It should further be appreciated that user 310 and user 320 can contribute other input to conversation 330, such as images, emojis, audio files, video files, etc., and that embodiments described herein are able to use any input to conversation 330 in identifying and presenting visual media for display within the messaging application.

Conversation 330 is converted to text string 335. In one embodiment, the text of conversation 330 is converted to text string 335. In some embodiments, other content of conversation 330 (e.g., images or emojis) are converted to text for inclusion in text string 335. For example, the other content may have or include metadata such as tags or labels that can be used within text string 335. In general, conversation 330 is converted to text string 335 such that the content of conversation 330 can be parsed and any sentiment conveyed within the conversation can be identified.

Conversation analyzer 340 received text string 335 and analyzes the content of text string 335 to identify a sentiment of the communication between user 310 and user 320. In one embodiment, a plurality of sentiments and a confidence level for each of the plurality of sentiments are identified. A sentiment is selected from the plurality of sentiments based at least in part on the confidence level for each of the plurality of sentiments.

In one embodiment, keywords are extracted from text string 335 (e.g., for searching against media file library 232). At least one keyword 345 is identified as indicative of a sentiment. In another embodiment, a keyword is generated based on the content of text string 335. For example, conversation analyzer 340 may include a list of terms that convey a sentiment or are possible to convey a sentiment, and the extracted keywords are compared to the list of term. At least one keyword 345 indicative of a sentiment is used for identifying at least one item of visual media representative of the sentiment.

In one embodiment, at least one keyword 345 is provided to search engine 350 as a search query, which performs a search for visual media related to a sentiment represented by keyword 345. It should be appreciated that the search engine 350 can be located in the electronic device, a remote computer system (e.g., remote computer system 230), or components of search engine 350 can be distributed across multiple computer systems.

One or more keyword 345 is used to identify at least one item of visual media representative of the sentiment. In some embodiments, media file library 232 is searched according to a search query including a sentiment. Search engine 350 returns search results 355 including at least one item of visual media representative of the sentiment. Search results 355 are received at visual media selector 360.

Visual media selector 360 is configured to select an item of visual media and communicated the selected item to the messaging application for display within the messaging application in an area proximate to (e.g., under, next to, partially obscuring, etc.) conversation 330. In one embodiment, visual media selector 360 automatically selects selected visual media 365 for display. In another embodiment, visual media selector 360 presents at least one of user 310 and 320 with a plurality of visual media selections representative of the sentiment in the messaging application. In response to a selection from at least one of user 310 and 320, visual media selector 360 selects selected visual media 365 for display proximate conversation 330. For example, where text string includes words identifying a milestone event (e.g., a graduation or a wedding), and the visual media representative of the sentiment includes an acknowledgement of the milestone event.

In accordance with various embodiments, visual content (e.g., media files) can be automatically sent to user 310 and user 320 based on the content of conversation 330 (e.g., text communications). Consider the example of an interaction between user 310 and user 320 chatting in a messaging application. User 310 has just achieved a milestone (e.g., had a birthday or just graduated). User 320 then sends user 310 a message such as “Happy birthday” or “Congratulations”. The described embodiment monitors conversation 330 (e.g., text string 335) to provide relevant media content or animation (referred here as “visual media”) that can be displayed back to user 310 automatically with either no explicit SEND interaction from user 320 or through the active participation of user 320 to select the visual media that will be sent by manually deciding among a choice of visual media. That visual media can be a free or paid digital good that users can purchase electronically (through in-app purchase for example). In some embodiments, user 320 can also select to attach to the visual media a new action, for example, attach a gift card or a monetary payment so the recipient gets both.

In the example where user 320 has attached further elements to the visual media, user 310 upon receiving and viewing the media will either automatically be offered the digital object and agree to receiving it (digital money transfer, gift card) or have the option to manually accept it or to click for further action related to the receipt of the digital good. For example, user 310 must enter their name or email to receive the digital good, or complete a series of other steps to receive it. The implementation of this feature (visual media, digital good, and potential action) can be done programmatically to define the different elements mentioned here. A script that describes actions, timing, visual media, etc. can be written for that purpose.

In various embodiments, the visual media takes over at least a portion of the screen. In many cases, the visual media can play on the whole screen, and not be limited to the text snippet being sent. The same applies in social media apps and websites and any destination where users are generating content.

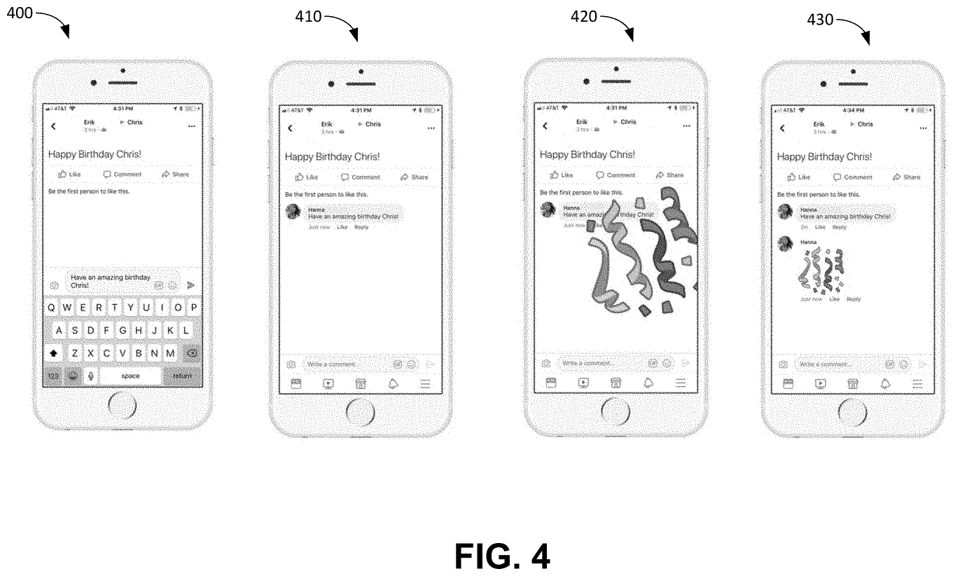

FIGS. 4-6 illustrate screenshots of examples of automatic sending of a media file, according to various embodiments. With reference to FIG. 4, an example of automatic sending of a media file in conjunction with the use of a messaging application is illustrated. At screenshot 400, a message conveying “Have an amazing birthday Chris!” is entered into the text input field of the messaging application. At screenshot 410, the message is received at the messaging application. The message is processed (e.g., parsed) and, as shown at screenshot 420, visual media representing streamers (e.g., a media file) is automatically sent to the recipient of the message, where the visual media is generated based on the content of the message. For example, other types of visual media indicative of celebrating a birthday could automatically be sent. It should be appreciated that the visual media can overlay the messaging application, and can cover any portion of the screen. At screenshot 430, the visual media is embedded into the message string.

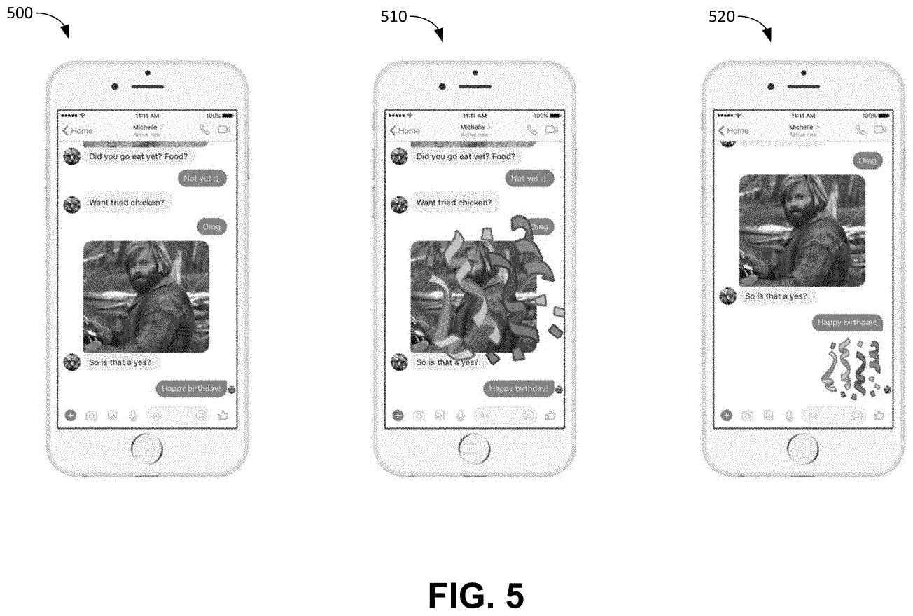

With reference to FIG. 5, another example of automatic sending of a media file in conjunction with the use of a messaging application is illustrated. At screenshot 500, a message conveying “Happy birthday!” is received at the messaging application. The message is processed (e.g., parsed) and, as shown at screenshot 510, visual media representing streamers (e.g., a media file) is automatically sent to the recipient of the message, where the visual media is generated based on the content of the message. For example, other types of visual media indicative of celebrating a birthday could automatically be sent. It should be appreciated that the visual media can overlay the messaging application, and can cover any portion of the screen. At screenshot 520, the visual media is embedded into the message string.

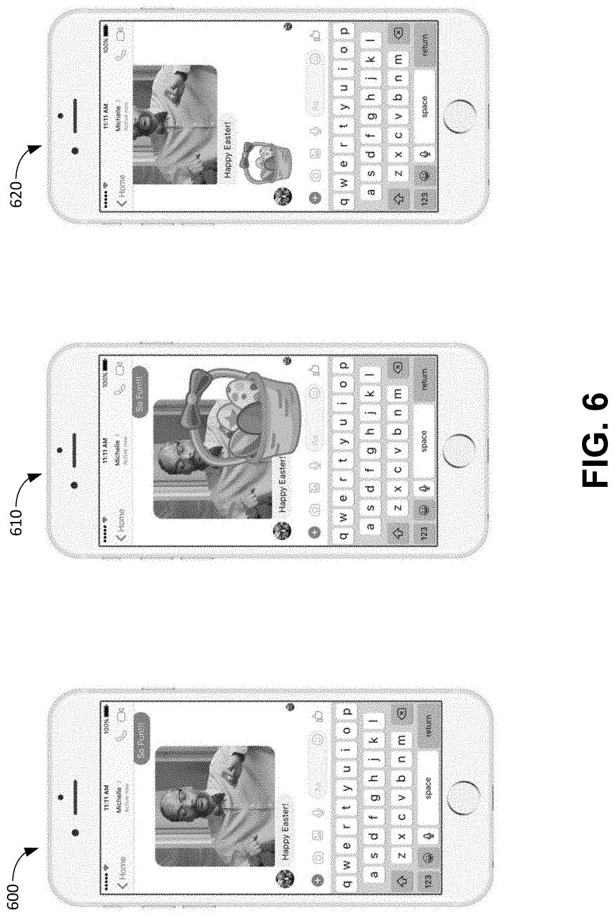

With reference to FIG. 6, another example of automatic sending of a media file in conjunction with the use of a messaging application is illustrated. At screenshot 600, a message conveying “Happy Easter!” is received at the messaging application. The message is processed (e.g., parsed) and, as shown at screenshot 610, visual media representing a basket with Easter eggs (e.g., a media file) is automatically sent to the recipient of the message, where the visual media is generated based on the content of the message. For example, other types of visual media indicative of celebrating Easter could automatically be sent. It should be appreciated that the visual media can overlay the messaging application, and can cover any portion of the screen. At screenshot 620, the visual media is embedded into the message string.

In accordance with various embodiments, visual content (e.g., media files) can be presented in areas over or around the text communications responsive to a mood or sentiment of the communication. For example, when chatting with others or conversing on social media or even more passively just consuming social media, a sentiment (happy, joyful, bashful, angry, serious, etc.) for the content can be identified.

In accordance with some embodiments, a text string is analyzed to understand the sentiment of a communication. One or more sentiments are identified, each sentiment having an associated confidence level. The confidence level is used for relative ranking of the likelihood of a particular sentiment. In some embodiments, the confidence level is compared to a confidence threshold. For example, the top sentiment of a ranking of possible sentiments may only be identified if the confidence level satisfies the confidence threshold. The identified sentiment is used to identify at least one item of visual media that corresponds to that sentiment. A selected visual media item is displayed proximate the communication (e.g., below, above, under, over, or next to).

The visual media changes as sentiment in the conversation changes, also referred to herein as “mood lighting.” Visual media as described above can be an animation (confetti for an excited conversation) of a form of looping content (for example, waves on a beach to represent calm). As in the case described above, potential automated or manually initiated action could be added to this visual media.

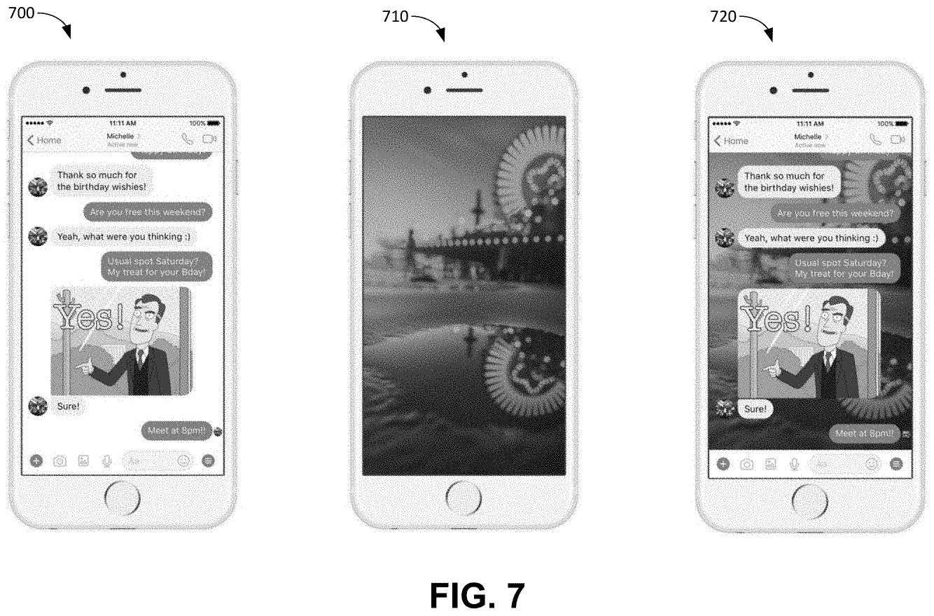

FIG. 7 illustrates screenshots of an example of a media file as mood lighting, according to an embodiment. At screenshot 700, a text conversation in a messaging application between two users is shown. In one embodiment, the text of the text conversation is analyzed and visual media is automatically selected for presentation within the messaging application. In one embodiment, the visual media is selected based on the text. In one embodiment, the visual media is selected to convey a sentiment covered by the text. For example, the sentiment of the text conversation of screenshot 700 is celebration of a birthday. Visual media is selected that conveys the sentiment of celebration. As illustrated in screenshot 710, a media file is selected for display in the background of the messaging application that conveys the sentiment of celebration. The example of screenshot 710 is a video file of a boardwalk that is lit up in celebration. As illustrated in screenshot 720, the visual media is displayed in the background of the messaging application, enhancing the mood of the text conversation. It should be appreciated that in accordance with some embodiments, the visual media is selected by one of the users.

### Example Methods of Operation of Presenting Visual Media

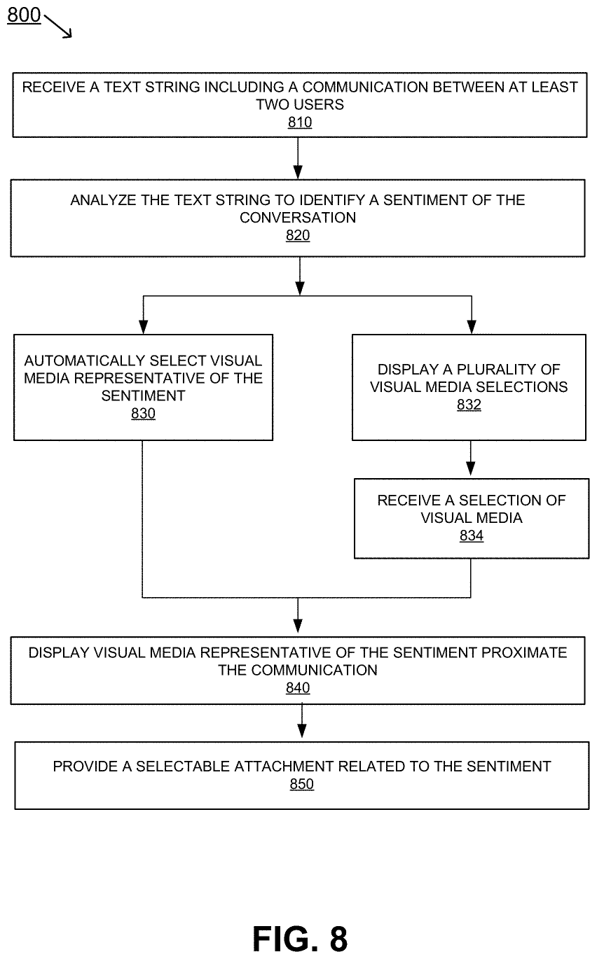

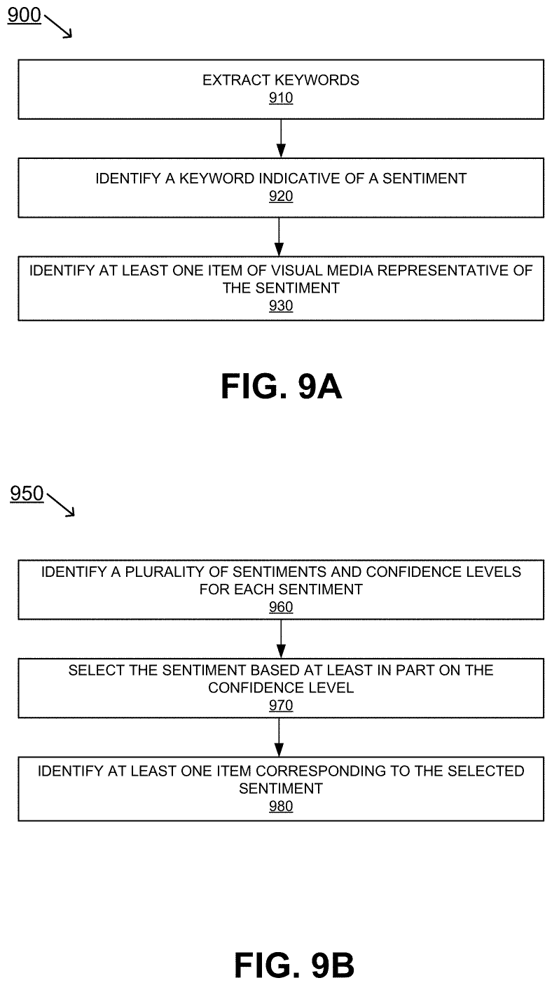

FIGS. 8, 9A, and 9B illustrate flow diagrams 800, 900, and 950 of an example method for presenting visual media, according to various embodiments. Procedures of this method may be described with reference to elements and/or components of various figures described herein. It is appreciated that in some embodiments, the procedures may be performed in a different order than described, that some of the described procedures may not be performed, and/or that one or more additional procedures to those described may be performed. Flow diagrams 800, 900, and 950 include some procedures that, in various embodiments, are carried out by one or more processors under the control of computer-readable and computer-executable instructions that are stored on non-transitory computer-readable storage media. It is further appreciated that one or more procedures described in flow diagram 800 may be implemented in hardware, or a combination of hardware with firmware and/or software.

With reference to FIG. 8, at procedure 810 of flow diagram 800, a text string including communication between a first user using a messaging application at a first electronic device and a second user using the messaging application at a second electronic device is received.

At procedure 820, the text string is analyzed to identify a sentiment of the communication. In one embodiment, procedure 820 includes the procedures of flow diagram 900 of FIG. 9A. At procedure 910, keywords are extracted from the text string. At procedure 920, at least one keyword indicative of a sentiment is identified. At procedure 930, at least one item of visual media representative of the sentiment is identified.

In one embodiment, procedure 820 includes the procedures of flow diagram 950 of FIG. 9B. At procedure 960, a plurality of sentiments and a confidence level for each of the plurality of sentiments is identified. At procedure 970, a sentiment is selected from the plurality of sentiments based at least in part on the confidence level for each of the plurality of sentiments. At procedure 980, at least one item of visual media corresponding to the selected sentiment is identified.

With reference to FIG. 8, in one embodiment, at procedure 830, the visual media representative of the sentiment is automatically selected. In another embodiment, as shown at procedure 832, a plurality of visual media selections representative of the sentiment are displayed in the messaging application at least at the first electronic device. At procedure 834, a selection of the visual media representative of the sentiment from the plurality of visual media selections representative of the sentiment is received.

At procedure 840, visual media representative of the sentiment is displayed within the messaging application and proximate the communication. In on embodiment, as shown at procedure 850, a selectable attachment related to the sentiment of the communication is provided within the messaging application.

### Conclusion

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. Many aspects of the different example embodiments that are described above can be combined into new embodiments. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A computer-implemented method for presenting visual media, the method comprising:
receiving a text string comprising communication between a first user using a messaging application at a first electronic device and a second user using the messaging application at a second electronic device;
analyzing the text string to identify a sentiment of the communication; and
displaying visual media representative of the sentiment within the messaging application and proximate the communication.

2. The method of claim 1, further comprising:
automatically selecting the visual media representative of the sentiment.

3. The method of claim 1, further comprising:
displaying a plurality of visual media selections representative of the sentiment in the messaging application at least at the first electronic device; and
receiving a selection of the visual media representative of the sentiment from the plurality of visual media selections representative of the sentiment.

4. The method of claim 1, further comprising:
providing a selectable attachment related to the sentiment of the communication within the messaging application.

5. The method of claim 1, wherein the analyzing the text string to identify the sentiment of the communication comprises:
extracting keywords from the text string;
identifying at least one keyword indicative of a sentiment; and
identifying at least one item of visual media representative of the sentiment.

6. The method of claim 1, wherein the analyzing the text string to identify the sentiment of the communication comprises:
identifying a plurality of sentiments and a confidence level for each of the plurality of sentiments; and
selecting the sentiment from the plurality of sentiments based at least in part on the confidence level for each of the plurality of sentiments.

7. The method of claim 6, further comprising:
identifying at least one item of visual media corresponding to the selected sentiment.

8. The method of claim 1, wherein the text string comprises words identifying a milestone event, and wherein the visual media representative of the sentiment comprises an acknowledgement of the milestone event.

9. The method of claim 1, wherein the visual media comprises a color of a background of the messaging application.

10. A non-transitory computer readable storage medium having computer readable program code stored thereon for causing a computer system to perform a method for presenting visual media, the method comprising:
receiving a text string comprising communication between a first user using a messaging application at a first electronic device and a second user using the messaging application at a second electronic device;
analyzing the text string to identify a sentiment of the communication;
automatically selecting visual media representative of the sentiment; and
displaying the visual media representative of the sentiment within the messaging application and proximate the communication.

11. The non-transitory computer readable storage medium of claim 10, the method further comprising:
providing a selectable attachment related to the sentiment of the communication within the messaging application.

12. The non-transitory computer readable storage medium of claim 10, wherein the analyzing the text string to identify the sentiment of the communication comprises:
extracting keywords from the text string;
identifying at least one keyword indicative of a sentiment; and
identifying at least one item of visual media representative of the sentiment.

13. The non-transitory computer readable storage medium of claim 10, wherein the analyzing the text string to identify the sentiment of the communication comprises:
identifying a plurality of sentiments and a confidence level for each of the plurality of sentiments; and
selecting the sentiment from the plurality of sentiments based at least in part on the confidence level for each of the plurality of sentiments.

14. The non-transitory computer readable storage medium of claim 13, the method further comprising:
identifying at least one item of visual media corresponding to the selected sentiment.

15. The non-transitory computer readable storage medium of claim 10, wherein the text string comprises words identifying a milestone event, and wherein the visual media representative of the sentiment comprises an acknowledgement of the milestone event.

16. The non-transitory computer readable storage medium of claim 10, wherein the visual media comprises a color of a background of the messaging application.

17. A computer system comprising:
a data storage unit; and
a processor coupled with the data storage unit, the processor configured to:
receive a text string comprising communication between a first user using a messaging application at a first electronic device and a second user using the messaging application at a second electronic device;
analyze the text string to identify a sentiment of the communication comprising:
identify a plurality of sentiments and a confidence level for each of the plurality of sentiments;
select the sentiment from the plurality of sentiments based at least in part on the confidence level for each of the plurality of sentiments; and
identify at least one item of visual media corresponding to the selected sentiment;
automatically select visual media representative of the sentiment from the at least one item of visual media; and
display the visual media representative of the sentiment within the messaging application and proximate the communication.

18. The computer system of claim 17, the processor further configured to:
provide a selectable attachment related to the sentiment of the communication within the messaging application.

19. The computer system of claim 17, the processor further configured to:
extract keywords from the text string;
identify at least one keyword indicative of a sentiment; and
identify at least one item of visual media representative of the sentiment.
